(19) United States
(12) Patent Application Publication
(10) Pub. No.: US 2007/0047822 A1
(43) Pub. Date: Mar. 1, 2007

(54) Learning method for classifiers, apparatus, and program for discriminating targets

(75) Inventors: Yoshiro Kitamura, Kanagawa-ken (JP); Sadato Akahori, Kanagawa-ken (JP); Kensuke Terakawa, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/513,038

(22) Filed: Aug. 31, 2006

(30) Foreign Application Priority Data
Aug. 31, 2005 (JP) 251452/2005

(51) Int. Cl. G06K 9/62

(52) U.S. Cl. 382/224

(57) ABSTRACT

False positive detection of discrimination targets within images is reduced, while detection processes are accelerated. A partial image generating means generates a plurality of partial images by scanning a subwindow over an entire image. A candidate classifier judges whether each of the partial images represent a face (discrimination target), and candidate images that possibly represent faces are detected. A discrimination target discriminating means judges whether each of the candidate images represents a face. The candidate classifier has performed learning, employing reference sample images and in-plane rotated sample images.

### BACKGROUND OF THE INVENTION

1. Field of the Invention

The present invention is related to a learning method for classifiers that judge whether a discrimination target, such as a human face, is included in images. The present invention is also related to an apparatus and program for discriminating targets.

2. Description of the Related Art

The basic principle of face detection, for example, is classification into two classes, either a class of faces or a class not of faces. A technique called “boosting” is commonly used as a classification method for classifying faces. The boosting algorithm is a learning method for classifiers that links a plurality of weak classifiers to form a single strong classifier. Edge data of multiple resolution images are employed as characteristic amounts used for classification by the weak classifiers.

U.S. Patent Application Publication No. 20020102024 discloses a method that speeds up face detecting processes by the boosting technique. In this method, the weak classifiers are provided in a cascade structure, and only images which have been judged to represent faces by upstream weak classifiers are subject to judgment by downstream weak classifiers.

Not only images, in which faces are facing forward, are input into the aforementioned classifier. The images input into the classifier include those in which faces are rotated within the plane of the image (hereinafter, referred to as “in-plane rotated images”) and those in which the direction that the faces are facing is rotated (hereinafter, referred to as “out-of-plane rotated images”). The rotational range of faces which are capable of being discriminated by any one classifier is limited. A classifier can discriminate faces if they are rotated within a range of about 30° in the case of in-plane rotation, and within a range of about 30° to 60° in the case of out-of-plane rotation. In order to be able to discriminate faces which are rotated over a greater rotational range, it is necessary to prepare a plurality of classifiers, each capable of discriminating faces of different rotations, and to cause all of the classifiers to perform judgment regarding whether the images represent faces (refer to, for example, S. Lao, et al., “Fast Omni-Directional Face Detection”, MIRU2004, pp. II271-II276, July 2004).

S. Li and Z. Zhang, “FloatBoost Learning and Statistical Face Detection”, IEEE Transactions on Pattern Analysis and Machine Intelligence, Vol. 26, No. 9, pp. 1-12, September 2004, proposes a method in which it is judged whether images to be input into a plurality of classifiers, each capable of discriminating faces of different rotations, include out-of-plane rotated faces prior to input thereof. Thereafter, the plurality of classifiers are employed to judge whether the images represent faces. In the method proposed in this document, first, it is judged whether the images are out-of-plane rotated images of faces, with the faces being rotated within a range of −90° to +90°. Then, classifiers capable of discriminating out-of-plane rotated images of faces within ranges of −90° to −30°, −20° to +20°, and +30° to +90° respectively are employed to perform judgment regarding whether the images represent faces. Further, images which have been judged to represent faces by each of these classifiers are submitted to judgment by a plurality of classifiers capable of discriminating faces rotated at more finely segmented rotational ranges.

A major factor in attempts to accelerate judgment processes is at how early a step candidates that make up a large portion of images and are clearly not faces, such as backgrounds and bodies, can be discriminated. In the method disclosed by the aforementioned Lao et al. document, all of the plurality of classifiers, each of which corresponds to a different rotational angle, perform judgment with respect to candidates which are clearly not faces, thereby causing a problem that the judgment speed becomes slow. In the method disclosed by the aforementioned Li and Zhang document, there is a problem that out-of-plane rotated faces (faces in profile) can be detected, but faces which are rotated within the planes of images cannot be detected.

### SUMMARY OF THE INVENTION

The present invention has been developed in view of the foregoing circumstances. It is an object of the present invention to provide a learning method for classifiers that enables acceleration of detection processes while maintaining high detection rates with respect to in-plane and out-of-plane rotated images. It is another object of the present invention to provide a target discriminating apparatus and a target discriminating program that employs classifiers which have performed learning according to the learning method of the present invention.

The leaning method of the present invention is a learning method for a classifier that employs a plurality of discrimination results obtained by a plurality of weak classifiers to perform final discrimination regarding whether an image represents a discrimination target, comprising the steps of:

learning reference sample images of the discrimination target, in which the discrimination targets are facing a predetermined direction; and

learning in-plane rotated sample images of the discrimination target, in which the discrimination targets are rotated within the plane of the reference sample images.

The target discriminating apparatus of the present invention comprises:

partial image generating means, for scanning a subwindow of a set number of pixels over an entire image to generate partial images;

candidate detecting means, for judging whether the partial images generated by the partial image generating means represents a discrimination target, and detecting partial images which possibly represent the discrimination target as candidate images; and

discrimination target judging means, for judging whether the candidate images detected by the candidate detecting means represent the discrimination target;

the candidate detecting means being equipped with a candidate classifier that employs a plurality of discrimination results obtained by a plurality of weak classifiers to perform final discrimination regarding whether the partial images represent the discrimination target; and

the candidate classifier learning reference sample images of the discrimination target, in which the discrimination targets are facing a predetermined direction, and in-plane rotated sample images of the discrimination target, in which the discrimination targets are rotated within the plane of the reference sample images.

The target discriminating program of the present invention is a program that causes a computer to function as:

partial image generating means, for scanning a subwindow of a set number of pixels over an entire image to generate partial images;

candidate detecting means, for judging whether the partial images generated by the partial image generating means represents a discrimination target, and detecting partial images which possibly represent the discrimination target as candidate images; and

discrimination target judging means, for judging whether the candidate images detected by the candidate detecting means represent the discrimination target;

the candidate detecting means being equipped with a candidate classifier that employs a plurality of discrimination results obtained by a plurality of weak classifiers to perform final discrimination regarding whether the partial images represent the discrimination target; and

the candidate classifier learning reference sample images of the discrimination target, in which the discrimination targets are facing a predetermined direction, and in-plane rotated sample images of the discrimination target, in which the discrimination targets are rotated within the plane of the reference sample images.

Here, the discrimination targets pictured within the reference sample images may face any predetermined direction. However, it is preferable that the discrimination targets face forward within the reference sample images.

The candidate classifier may further learn:

out-of-plane rotated sample images of the discrimination target, in which the direction that the discrimination targets are facing in the reference sample images is rotated; and

out-of-plane in-plane rotated sample images of the discrimination target, in which the discrimination targets within the out-of-plane rotated sample images are rotated within the plane of the images.

Any discrimination method may be employed by the candidate classifier, as long as it employs a plurality of discrimination results obtained by a plurality of weak classifiers to perform discrimination regarding whether an image represents a discrimination target. For example, all of the weak classifiers may perform discrimination on partial images, and final discriminations may be performed by the candidate classifier employing the plurality of discrimination results obtained thereby. Alternatively, the weak classifiers may be provided in a cascade structure, and judgment may be performed by downstream weak classifiers only on partial images, which have been judged to represent the discrimination target by an upstream weak classifier.

It is preferable for the candidate classifier to learn a plurality of in-plane rotated sample images having different angles of rotation, and a plurality of out-of-plane rotated sample images having different angles of rotation.

Further, the candidate detecting means may comprise a candidate narrowing means, for narrowing a great number of candidate images judged by the candidate classifier to a smaller number of candidate images, the candidate narrowing means comprising:

an in-plane rotated classifier, having a plurality of weak classifiers which have learned the reference sample images and the in-plane rotated sample images; and

an out-of-plane rotated classifier, having a plurality of weak classifiers which have learned the reference sample images and the out-of-plane rotated sample images. Note that the candidate narrowing means may further comprise an out-of plane in-plane rotated classifier, having a plurality of weak classifiers which have learned the reference sample images and out-of-plane in-plane rotated sample images. Alternatively, the out-of-plane rotated classifier may further comprise weak classifiers which have performed learning employing the out-of-plane in-plane rotated sample images.

A configuration may be adopted, wherein:

the candidate detecting means comprises a plurality of the candidate narrowing means having cascade structures;

each candidate narrowing means is equipped with the in-plane rotated classifier and the out-of-plane rotated classifier; and

the angular ranges of the discrimination targets within the partial images capable of being discriminated by the in-plane rotated classifiers and the out-of-plane rotated classifiers are narrower from the upstream side to the downstream side of the cascade.

The learning method of the present invention is a learning method for a classifier that employs a plurality of discrimination results obtained by a plurality of weak classifiers to perform final discrimination regarding whether an image represents a discrimination target, comprising the steps of: learning reference sample images of the discrimination target, in which the discrimination targets are facing a predetermined direction; and learning in-plane rotated sample images of the discrimination target, in which the discrimination targets are rotated within the plane of the reference sample images. Therefore, discrimination targets which are rotated within the planes of images can be discriminated. Accordingly, detection rates of the discrimination targets can be improved.

In the target discriminating apparatus and the target discriminating program of the present invention, the candidate classifier of the candidate detecting means is that which has learned reference sample images, in which the discrimination targets are facing forward, and in-plane rotated sample images, in which the discrimination targets within the reference images are rotated within the plane of the reference sample images. Therefore, discrimination targets which are rotated within the planes of images can be discriminated. Accordingly, detection rates of the discrimination targets can be improved.

Note that the candidate classifier may further learn out-of-plane rotated sample images, in which the direction in which discrimination targets within the reference images are facing is rotated, and out-of-plane in-plane rotated sample images of the discrimination target, in which the discrimination targets within the out-of-plane rotated sample images are rotated within the plane of the images. In this case, the candidate classifier can detect discrimination targets which are rotated in-plane, rotated out-of-plane, and rotated both out-of-plane and in-plane within images. Therefore, detection operations can be accelerated, thereby reducing the time required therefor.

The weak classifiers may be provided in a cascade structure, and judgment may be performed by downstream weak classifiers only on partial images, which have been judged to represent the discrimination target by an upstream weak classifier. In this case, the amount of calculations performed by the downstream weak classifiers can be greatly reduced, thereby further accelerating discrimination operations.

Further, the candidate classifier may learn a plurality of in-plane rotated sample images having different rotational angles and a plurality of out-of-plane rotated sample images having different rotational angles. In this case, the candidate classifier is capable of discriminating discrimination targets which are rotated at various rotational angles. Accordingly, the detection rate of the discrimination targets is improved.

A configuration may be adopted, wherein: the candidate detecting means comprises a candidate narrowing means, for narrowing a great number of candidate images judged by the candidate classifier to a smaller number of candidate images, the candidate narrowing means comprising: an in-plane rotated classifier, having a plurality of weak classifiers which have learned the reference sample images and the in-plane rotated sample images; and an out-of-plane rotated classifier, having a plurality of weak classifiers which have learned the reference sample images and the out-of-plane rotated sample images. In this case, the candidate narrowing means, which ahs a lower false positive detection rate than the candidate classifier, narrows down the number of candidate images. Thereby, the number of candidate images to be discriminated by the discrimination target discriminating means is greatly reduced, and accordingly, the discrimination operation can be further accelerated.

A configuration may be adopted, wherein: the candidate detecting means comprises a plurality of the candidate narrowing means having cascade structures; each candidate narrowing means is equipped with the in-plane rotated classifier and the out-of-plane rotated classifier; and the angular ranges of the discrimination targets within the partial images capable of being discriminated by the in-plane rotated classifiers and the out-of-plane rotated classifiers are narrower from the upstream side to the downstream side of the cascade. In this case, candidate narrowing classifiers having lower false positive detection rates are employed to narrow down the number of candidate images toward the downstream candidate narrowing means. Thereby, the number of candidate images to be discriminated by the target discriminating means is greatly reduced, and accordingly, the discrimination operation can be further accelerated.

Note that the program of the present invention may be provided being recorded on a computer readable medium. Those who are skilled in the art would know that computer readable media are not limited to any specific type of device, and include, but are not limited to: floppy disks, CD's, RAM's, ROM's, hard disks, magnetic tapes, and internet downloads, in which computer instructions can be stored and/or transmitted. Transmission of the computer instructions through a network or through wireless transmission means is also within the scope of this invention. Additionally, computer instructions include, but are not limited to: source, object, and executable code, and can be in any language, including higher level languages, assembly language, and machine language.

### BRIEF DESCRIPTION OF THE DRAWINGS

FIG. 1 is a block diagram that illustrates the configuration of a target discriminating apparatus according to a first embodiment of the present invention.

FIGS. 2A, 2B, 2C, and 2D are diagrams that illustrate how a partial image generating means of FIG. 1 scans subwindows.

FIG. 3 is a block diagram that illustrates an example of a candidate classifier.

FIG. 4 is a diagram that illustrates how characteristic amounts are extracted from partial images, by weak classifiers of FIG. 1.

FIG. 5 is a graph that illustrates an example of a histogram of the weak classifier of FIG. 1.

FIG. 6 is a block diagram that illustrates the configuration of a classifier teaching apparatus that causes the candidate classifier of FIG. 1 to perform learning.

FIG. 7 is a diagram that illustrates examples of sample images fro learning, which are recorded in a database of the classifier teaching apparatus of FIG. 6.

FIG. 8 is a flow chart that illustrates an example of the operation of the classifier teaching apparatus of FIG. 6.

FIG. 9 is a block diagram that illustrates the configuration of a target discrimination apparatus according to a second embodiment of the present invention.

FIG. 10 is a block diagram that illustrates the configuration of a target discrimination apparatus according to a third embodiment of the present invention.

FIG. 11 is a block diagram that illustrates the configuration of a candidate classifier of a target discriminating apparatus according to a third embodiment of the present invention.

FIG. 12 is a flow chart that illustrates the processes performed by the candidate classifier of FIG. 11.

### BEST MODE FOR CARRYING OUT THE INVENTION

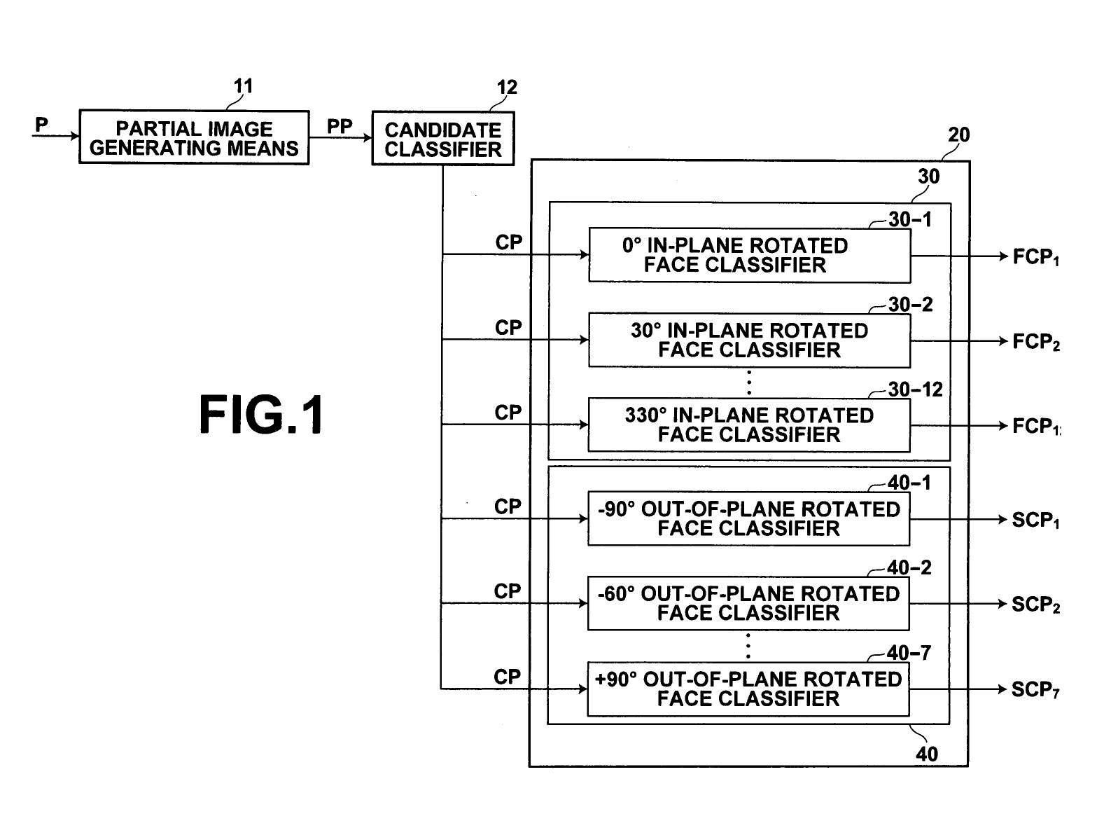

Hereinafter, embodiments of the target discriminating apparatus of the present invention will be described in detail with reference to the attached drawings. FIG. 1 is a block diagram that illustrates the configuration of a target discriminating apparatus 1 according to a first embodiment of the present invention. Note that the configuration of the target discrimination apparatus 1 is realized by executing an object recognition program, which is read into an auxiliary memory device, on a computer (a personal computer, for example). The object recognition program is recorded in a data medium such as a CD-ROM, or distributed via a network such as the Internet, and installed in the computer.

The target discriminating apparatus 1 of FIG. 1 discriminates faces, which are discrimination targets. The target discriminating apparatus 1 comprises: a partial image generating means 11, for generating partial images PP by scanning a subwindow W across an entire image P; a candidate classifier 12, for detecting candidate images CP that possibly represent faces, which are the discrimination targets; and a target detecting means 20, for discriminating whether the candidate images CP detected by the candidate classifier 12 represent faces.

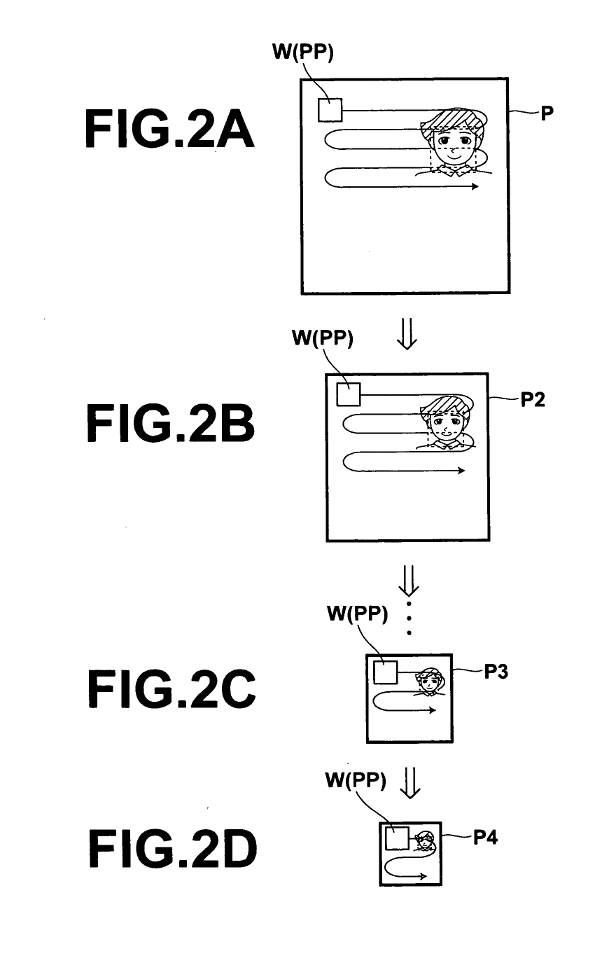

As illustrated in FIG. 2A, the partial image generating means 11 scans the subwindow W having a set number of pixels (32 pixels by 32 pixels, for example) within the entire image P, and cuts out regions surrounded by the subwindow W to generate the partial images PP having a set number of pixels. The partial image generating means 11 is configured to generate the partial images PP by scanning the subwindow W with intervals of a predetermined number of pixels.

Note that the partial image generating means 11 also functions to generate a plurality of lower resolution images P2, P3, and P4 from a single entire image P. The partial image generating means 11 generates partial images PP by scanning the subwindow W within the generated lower resolution images P2, P3, and P4 as well. Thereby, even in the case that a face (discrimination target) pictured in the entire image P does not fit within the subwindow W, it becomes possible to fit the face within the subwindow W in a lower resolution image. Accordingly, faces can be positively detected.

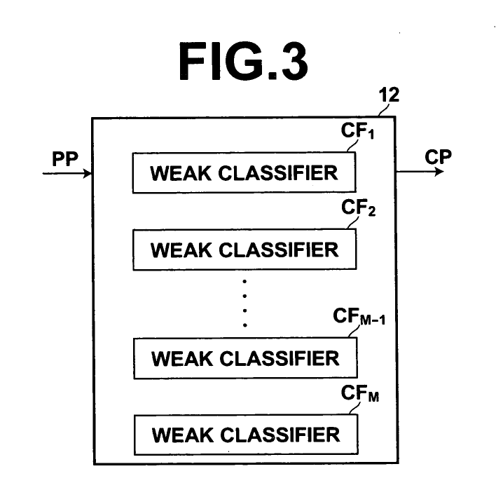

The candidate classifier 12 functions to perform binary discrimination regarding whether the partial images PP generated by the partial image generating means 11 represents faces, and comprises a plurality of weak classifiers CF₁ through CF_{M} (M is the number of weak classifiers), as illustrated in FIG. 3. Particularly, the candidate classifier 12 functions to discriminate both images, in which the discrimination target is rotated within the planes thereof (hereinafter, referred to as “in-plane rotated images”), and images, in which the direction that the discrimination target is facing is rotated (hereinafter, referred to as “out-of-plane rotated images”).

The candidate classifier 12 is that which has performed learning by the AdaBoosting algorithm, and comprises the plurality of weak classifiers CF₁ through CF_{M}. Each of the weak classifiers CF₁ through CF_{M} extracts characteristic amounts x from the partial images PP, and discriminates whether the partial images PP represent faces employing the characteristic amounts x. The candidate classifier 12 performs final judgment regarding whether the partial images PP represent faces, employing the discrimination results of the weak classifiers CF₁ through CF_{M}.

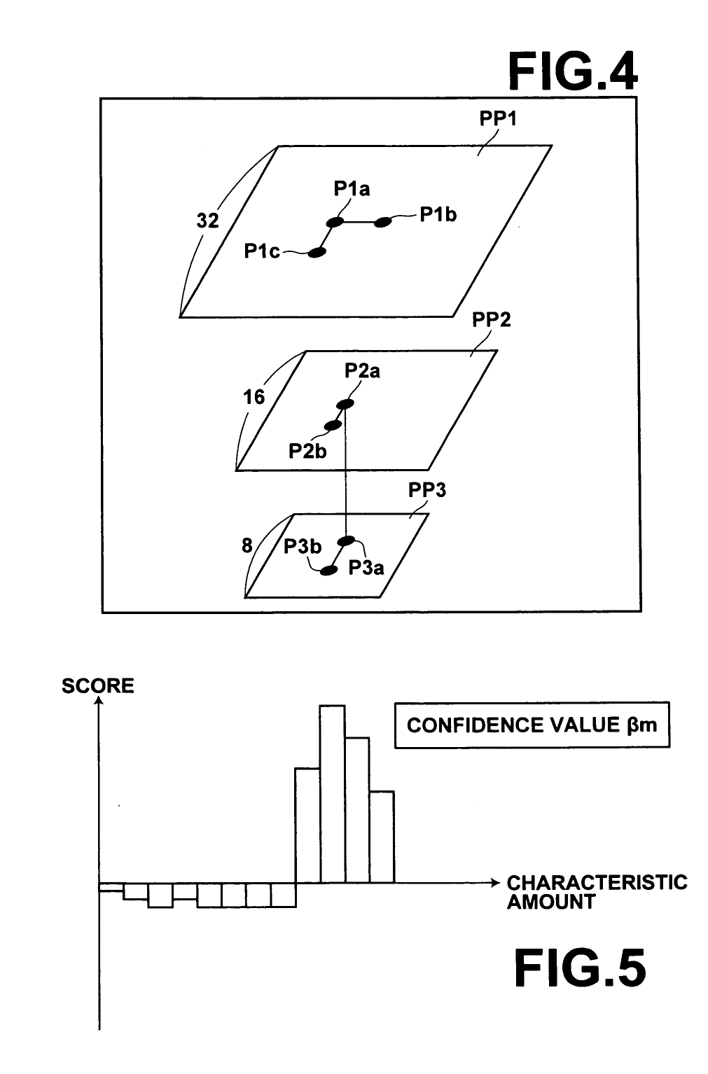

Specifically, each of the weak classifiers CF₁ through CF_{M} extract extracts brightness values or the like of coordinate positions P1a, P1b, and P1c within the partial images PP, as illustrated in FIG. 4. Further, brightness values or the like of coordinate positions P2a, P2b, P3a, and P3b are extracted from lower resolution images PP2 and PP3 of the partial images PP, respectively. Thereafter, the seven coordinate positions P1a through P3b are combined as pairs, and the differences in brightness values or the like of each of the pairs are designated to be the characteristic amounts x. Each of the weak classifiers CF₁ through CF_{M} employs different characteristic amounts. For example, the weak classifier CF₁ employs the difference in brightness values between coordinate positions P1a and P1c as the characteristic amount x, while the weak classifier CF₂ employs the difference in brightness values between coordinate positions P2a and P2b as the characteristic amount x.

Note that a case has been described in which each of the weak classifiers CF₁ through CF_{M} extracts characteristic amounts x. Alternatively, the characteristic amounts x may be extracted in advance for a plurality of partial images PP, then input into each of the weak classifiers CF₁ through CF_{M}. Further, a case has been described in which brightness values are employed as the characteristic amounts x. Alternatively, data regarding contrast or edges may alternatively be employed as the characteristic amounts x.

Each of the weak classifiers CF₁ through CF_{M} has a histogram such as that illustrated in FIG. 5. The weak classifiers CF₁ through CF_{M} output scores f1(x) through fM(x) according to the values of the characteristic amounts x based on these histograms. Further, the weak classifiers CF₁ through CF_{M} have confidence values β₁ through β_{M} that represent the levels of discrimination performance thereof. The candidate classifier 12 outputs final discrimination results, based on the scores fm(x) output from the weak classifiers CF₁ through CF_{M}, and the confidence values β₁ through β_{M}. Specifically, the final discrimination results can be expressed by the following Formula (1):
sign(Fm(x))=sign[Σm=1^{M}βm·fm(x)] (1)
In Formula (1), the discrimination result sign(Fm(x)) of the candidate classifier 12 is determined based on the sum of the discrimination scores βₘ·fₘ(x) (m=1, 2, 3, . . . M) of the weak classifiers CF₁ through CF_{M}.

Next, the target detecting means 20 will be described with reference to FIG. 1. The target detecting means 20 discriminates whether the candidate images CP detected by the candidate classifier 12 represent faces. The target detecting means 20 comprises: an in-plane rotated face classifier 30, for discriminating in-plane rotated images; and an out-of-plane rotated face classifier 40, for discriminating out-of-plane rotated images.

The in-plane rotated face classifier 30 comprises: a 0° in-plane rotated face classifier 30-1, for discriminating faces in which the angle formed by the center lines thereof and the vertical direction of the images that they are pictured in is 0°; a 30° in-plane rotated face classifier 30-2, for discriminating faces in which the aforementioned angle is 30°; and in-plane rotated face classifiers 30-3 through 30-12, for discriminating faces in which the aforementioned angle is within a range of 30° to 330°, in 30° increments. That is, the in-plane rotated face classifier 30 comprises a total of 12 classifiers. Note that for example, the 0° in-plane rotated face classifier 30-1 is capable of discriminating faces which are rotated within a range of −15° (=345°) to +15° with the center of rotational angular range being 0°.

Similarly, the out-of-plane rotated face classifier 40 comprises: a 0° out-of-plane rotated face classifier 40-1, for discriminating faces in which the direction that the face is facing within the image (angle) is 0°, that is, forward facing faces; a 30° out-of-plane rotated face classifier 40-2, for discriminating faces in which the aforementioned angle is 30°; and out-of-plane rotated face classifiers, for discriminating faces in which the aforementioned angle is within a range of −90° to +90°, in 30° increments. That is, the out-of-plane rotated face classifier 40 comprises a total of 7 classifiers. Note that for example, the 0° out-of-plane rotated face classifier 30-1 is capable of discriminating faces which are rotated within a range of −15° to +15° with the center of rotational angular range being 0°.

Note that each of the plurality of in-plane rotated face classifiers 30-1 through 30-12 and each of the plurality of out-of-plane rotated face classifiers 40-1 though 40-7 comprises a plurality of weak classifiers (not shown) which have performed learning by the boosting algorithm, similar to the aforementioned candidate classifier 12. Discrimination is performed by the plurality of in-plane rotated face classifiers 30-1 through 30-12 and the plurality of out-of-plane rotated face classifiers 40-1 through 40-7 in the same manner as that of the candidate classifier 12.

Here, the operation of the target discriminating apparatus 1 will be described with reference to FIGS. 1 through 5. First, the partial image generating means 11 generates a plurality of partial images PP, by scanning the subwindow W within the entire image P at uniform scanning intervals. Whether the generated partial images PP represent faces is judged by the candidate classifier 12, and candidate images CP that possibly represent faces are detected. Next, the target detecting means 20 judges whether the candidate images CP represent faces. Candidate images CP, in which faces are rotated in-plane and rotated out-of-plane, are discriminated by the target classifiers 30 and 40 of the target detecting means 20, respectively.

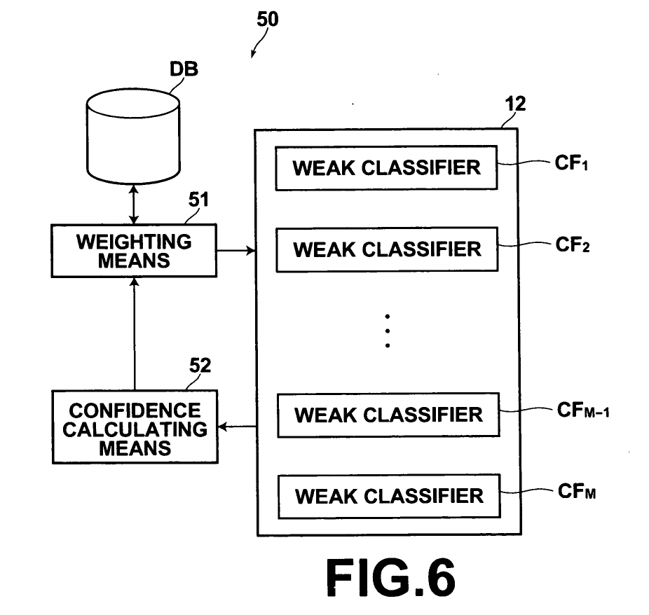

The plurality of weak classifiers CF₁ through CF_{M} of the aforementioned candidate classifier 12 have performed learning using the AdaBoosting algorithm, in which the weighting of sample images LP for learning is updated and repeatedly input into the weak classifiers CF₁ through CF_{M} (resampling). FIG. 6 is a block diagram that illustrates the configuration of a classifier teaching apparatus 50, for causing the candidate classifier 12 to perform learning.

The classifier teaching apparatus 50 comprises: a database DB, in which sample images LP for learning are recorded; a weighting means 51, for adding weights wₘ₋₁(i) to the sample images LP recorded in the database DB; and a confidence calculating means 52, for calculating the confidence of each weak classifier CF when the sample images LP, which have been weighted by wₘ₋₁(i), are input thereto.

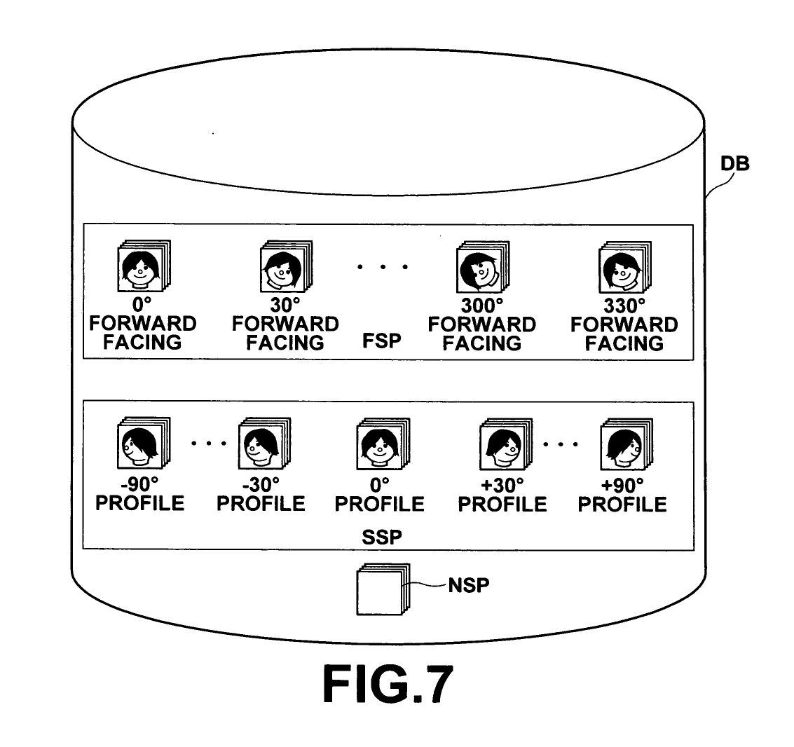

The sample images LP recorded in the database DB are images having the same number of pixels as the partial images PP. In-plane rotated sample images FSP and out-of-plane rotated sample images SSP are recorded in the database DB, as illustrated in FIG. 7. The in-plane rotated sample images FSP comprise 12 images of faces which are arranged at a predetermined position (the center, for example) within the images, and rotated in 30° increments. Similarly, the out-of-plane rotated sample images SSP comprise 7 images of faces which are arranged at a predetermined position (the center, for example) within the images, which face different directions within a range of −90° to +90°, in 30° increments. Further, the sample images LP comprise non-target sample images NSP that picture subjects other than faces, such as landscapes. Parameters yᵢ (i=1, 2, 3, . . . N, wherein N is the number of sample images LP) indicating whether the sample image LP represents a face is attached to the in-plane rotated sample images FSP, the out-of-plane rotated sample images SSP, and the non-target sample images NSP. In the case that a sample image LP represents a face, the parameter yᵢ=1, and in the case that a sample image LP does not represent a face, the parameter yᵢ=−1. The parameter yᵢ is 1 for the in-plane rotated sample images FSP and the out-of-plane rotated sample images SSP, and −1 for the non-target sample images NSP.

The weighting means 51 adds weights wₘ₋₁(i) (i=1, 2, 3, . . . N, wherein N is the number of sample images LP) to the sample images LP recorded in the database DB. The weights wₘ₋₁(i) are parameters that indicate the level of difficulty in discriminating a sample image LP. A sample image LP having a large weight wₘ₋₁(i) is difficult to discriminate, and a sample image LP having a small weight wₘ₋₁(i) is easy to discriminate. The weighting means 51 updates the weights wₘ₋₁(i) of each sample image LP based on the discrimination results obtained when they are input to a weak classifier CFₘ. The plurality of sample images LP having updated weights wₘ₁(i) are employed by a next weak classifier CFₘ₊₁ to perform learning. Note that when learning is performed by the first weak classifier CF₁, the weighting means 51 weights the sample images LP with weights w₀(i)=1/N.

The confidence calculating means 52 calculates the percentage of correct discriminations by each weak classifier CFₘ when the plurality of sample images LP, which have been weighted with weights wₘ₋₁(i), are input thereto as the confidence value βₘ thereof. Here, the confidence calculating means 52 assigns confidence values βₘ according to the weight wₘ₋₁. That is, greater confidence values βₘ are assigned to weak classifiers CFₘ that are able to discriminate sample images LP with large weights wₘ₋₁, and smaller confidence values βₘ are assigned to weak classifiers CFₘ that are able to discriminate sample images LP with little weights wₘ₋₁.

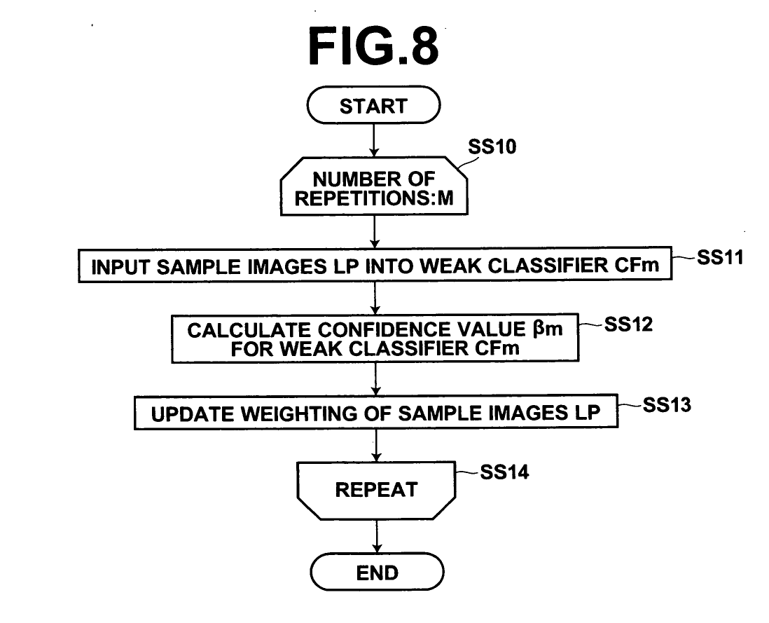

FIG. 8 is a flow chart that illustrates a preferred embodiment of the learning method for classifiers of the present invention. The classifier learning method will be described with reference to FIGS. 6 through 8. Note that the initial weights of the sample images LP are set to w₀(i)=1/N (i=1, 2, 3, . . . N).

First, when the sample images LP are input to a weak classifier CFₘ (step SS11), the confidence value βₘ is calculated (step SS12), based on the discrimination results of the weak classifier CFₘ.

Specifically, first, the error rate err of the weak classifier CFₘ is calculated by the following formula (2).
err=Σi=1^{N}wₘ₋₁(i)I(yᵢ≠fₘ(xᵢ)) (2)
In Formula (2), when the characteristic amounts xᵢ of the sample images LP are input to the weak classifier CFₘ, in the case that the discrimination results thereby differs from the parameters yᵢ attached to the sample images LP, that is, (yᵢ≠fₘ(xᵢ)), this signifies that the error rate err increases proportionately with the weighting wₘ₋₁(i) of the sample images LP.

Next, the confidence value βₘ of the weak classifier CFₘ is calculated based on the calculated error rate err, according to the following Formula (3).
βₘ=log((1−err)/err) (3)
The confidence value βₘ is learned as a parameter that indicates the level of discrimination performance of the weak classifier CFₘ.

Meanwhile, the weighting means 51 updates the weighting wₘ(i) of the sample images LP (step SS13) based on the discrimination results of the weak classifier CFₘ, according to the following formula (4).
wₘ(i)=wₘ₋₁(i)·exp[βₘ·I(yᵢ≠fₘ(xᵢ))] (4)
In Formula (4), the weighting of the sample images LP are updated such that the weights of sample images LP which have been correctly discriminated by the weak classifier CFₘ are increased, and the weights of sample images LP which have been incorrectly discriminated by the weak classifier CFₘ are decreased. Note that the weights of the sample images LP are normalized such that they ultimately become Σᵢ₋₁^{N}wₘ(i)=1.

Learning of a next weak classifier CFₘ₊₁ is performed, employing the sample images LP, of which the weights wₘ(i) have been updated (steps SS11 through SS14). The learning process is repeated M times. Then, the candidate classifier 12 represented by the following Formula (5) is completed, and the learning process ends.
sign(Fₘ(x))=sign[βₘ·fₘ(x)] (5)

Note that the learning method for the candidate classifier has been described with reference to FIG. 8. Note that the in-plane rotated face classifier 30 and the out-of-plane rotated face classifier 40 perform learning by similar learning methods. However, only reference sample images SP, the in-plane rotated sample images FSP and the non-target sample images NSP, and not the out-of-plane rotated sample images SSP, are employed during learning performed by the in-plane rotated face classifier 30. Further, each of the in-plane rotated face classifiers 30-1 through 30-12 performs learning employing sample images FSP, in which the faces are provided at rotational angles to be discriminated thereby. For example, the in-plane rotated face classifier 30-1 performs learning employing in-plane rotated sample images FSP, in which faces are rotated in-plane within a range of −15° (=345°) to +15 °.

Similarly, only the reference sample images SP, the out-of-plane rotated sample images SSP and the non-target sample images NSP, and not the in-plane rotated sample images FSP, are employed during learning performed by the out-of-plane rotated face classifier 40. Further, each of the out-of-plane rotated face classifiers 40-1 through 40-7 performs learning employing sample images SSP, in which the faces are provided at rotational angles to be discriminated thereby. For example, the out-of-plane rotated face classifier 40-1 performs learning employing out-of-plane rotated sample images SSP, in which faces are rotated out-of-plane within a range of −15° (=345°) to +15°.

As described above, the candidate classifier 12 has performed learning to discriminate both the in-plane rotated sample images FSP and the out-of-plane rotated sample images SSP as representing faces. For this reason, the candidate classifier 12 is capable of detecting partial images PP, in which faces are rotated in-plane and out-of-plane, in addition to those in which faces are facing a predetermined direction (forward), as the candidate images CP. On the other hand, partial images PP which are not of faces may also be discriminated as candidate images CP by the candidate classifier 12, and as a result, the false positive detection rate of the candidate classifier 12 increases.

However, partial images PP which have been cut out from portions of an image that clearly do not represent faces, such as the sky or the sea in the background, are discriminated to not represent faces by the candidate classifier 12, prior to being discriminated by the target detecting means 20. As a result, the number of candidate images CP that need to be discriminated by the target detecting means 20 is greatly reduced. Accordingly, the discrimination operations can be accelerated. Further, detailed discrimination operations are performed by the in-plane rotated face classifier 30 and the out-of-plane rotated face classifier 40 of the target detecting means 20, and therefore the false positive detection rate of the target discriminating apparatus 1 as a whole can be kept low. That is, it would appear that the false positive detection rate of the target discriminating apparatus 1 as a whole will increase due to the high false positive detection rate of the candidate classifier 12. However, the target detecting means 20 maintains the false detection rate of the target discriminating apparatus 1 as a whole low. At the same time, the candidate classifier 12 reduces the number of partial images PP to undergo the discrimination operations by the target detecting means 20, thereby accelerating the discrimination operations.

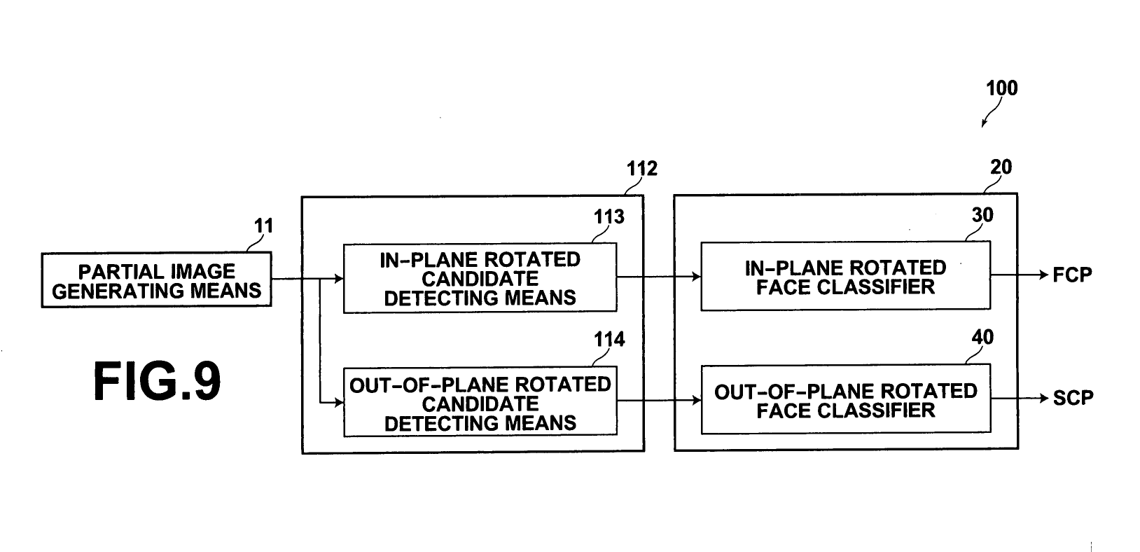

FIG. 9 is a block diagram that illustrates the configuration of a target discrimination apparatus 100 according to a second embodiment of the present invention. The target discrimination apparatus 100 will be described with reference to FIG. 9. Note that the constituent parts of the target discrimination apparatus 100 which are the same as those of the target discrimination apparatus 1 will be denoted by the same reference numerals, and detailed descriptions thereof will be omitted.

The target discriminating apparatus 100 of FIG. 9 differs from the target discriminating apparatus 1 of FIG. 1 in that a candidate classifier 112 comprises: an in-plane rotated candidate detecting means 113; and an out-of-plane rotated candidate detecting means 114. The in-plane rotated candidate detecting means 113 discriminates faces which are rotated in-plane, and the out-of-plane rotated candidate detecting means 114 discriminates faces which are rotated out-of-plane (faces in profile). The in-plane rotated candidate detecting means 113 and the in-plane rotated face classifier 30 have cascade structures. The in-plane rotated face classifier 30 is configured to perform further discriminations on in-plane rotated candidate images detected by the in-plane rotated candidate detecting means 113. The out-of-plane rotated candidate detecting means 114 and the out-of-plane rotated face classifier 40 have cascade structures. The out-of-plane rotated face classifier 40 is configured to perform further discriminations on out-of-plane rotated candidate images detected by the out-of-plane rotated candidate detecting means 114.

The in-plane rotated candidate detecting means 113 and the out-of-plane rotated candidate detecting means 114 each comprise a plurality of weak classifiers, which have performed learning by the aforementioned AdaBoosting algorithm. The in-plane rotated candidate detecting means 113 performs learning employing in-plane rotated sample images FSP and the reference sample images SP. The out-of-plane rotated candidate detecting means 114 performs learning employing out-of-plane rotated sample images SSP and the reference sample images SP.

In this manner, by including the two candidate detecting means 113 and 114 within the candidate classifier 112, the false positive detection rate of the candidate classifier 12 can be kept low. At the same time, the number of partial images PP to undergo the discrimination operations by the target detecting means 20 is reduced, thereby accelerating the discrimination operations.

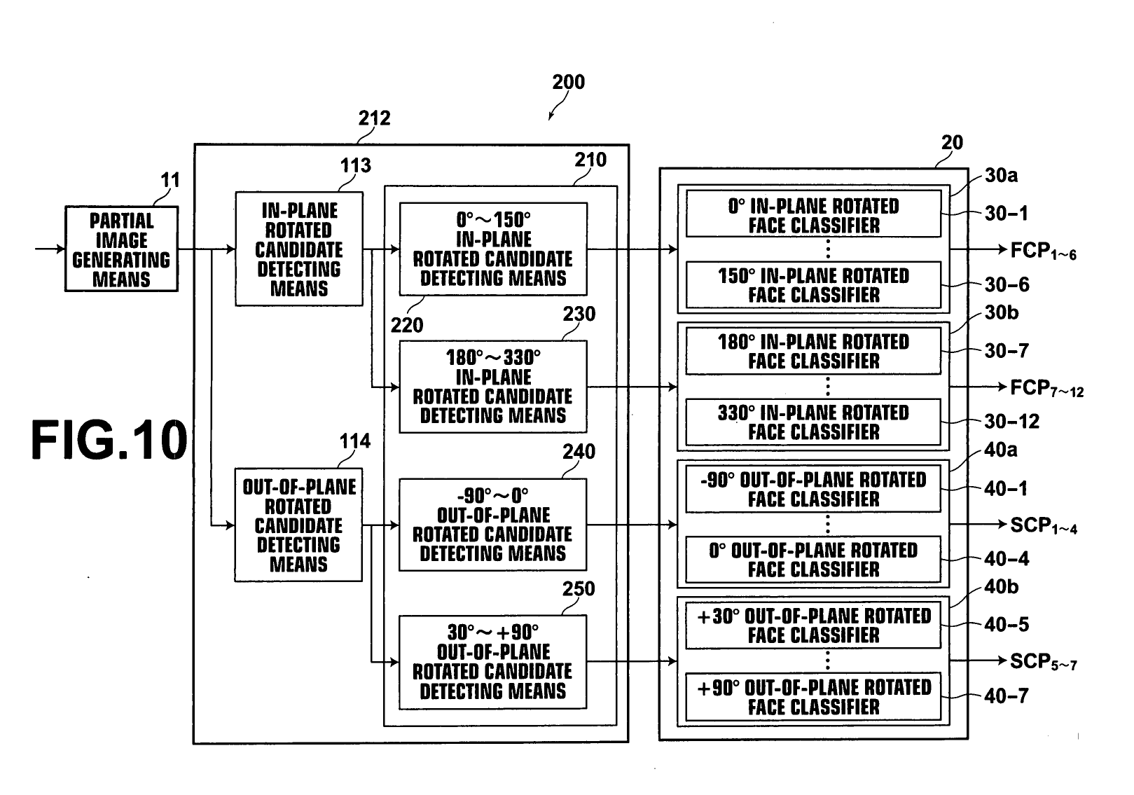

FIG. 10 is a block diagram that illustrates the configuration of a target discrimination apparatus 200 according to a third embodiment of the present invention. The target discrimination apparatus 200 will be described with reference to FIG. 10. Note that the constituent parts of the target discrimination apparatus 200 which are the same as those of the target discrimination apparatus 100 will be denoted by the same reference numerals, and detailed descriptions thereof will be omitted.

The target discriminating apparatus 200 of FIG. 10 differs from the target discriminating apparatus 100 of FIG. 9 in that a candidate classifier 212 further comprises a candidate narrowing means 210. The candidate narrowing means 210 comprises: a 0°-150° in-plane rotated candidate classifier 220, for discriminating faces which are rotated in-plane within a range of 0° to 150°; and a 180°-330° in-plane rotated candidate classifier 230, for discriminating faces which are rotated in-plane within a range of 180° to 330°. The candidate narrowing means 210 further comprises: a −90°-0 out-of-plane rotated candidate classifier 240, for discriminating faces which are rotated out-of-plane within a range of −90° to 0°; and a +30°-+90° out-of-plane rotated candidate classifier 250, for discriminating faces which are rotated out-of-plane within a range of +30° to +90°.

Candidate images CP, which have been judged to represent in-plane rotated images by the in-plane rotated candidate detecting means 113, are input to the in-plane rotated candidate classifiers 220 and 230. Candidate images CP, which have been judged to represent out-of-plane rotated images by the out-of-plane rotated candidate detecting means 114, are input to the out-of-plane rotated candidate classifiers 240 and 250.

Further, candidate images CP, which have been judged to represent faces by the 0°-150° in-plane rotated candidate classifier 220, are input to the in-plane rotated face classifiers 30-1 through 30-6, to perform discrimination of the faces therein. Candidate images CP, which have been judged to represent faces by the 180°-330° in-plane rotated candidate classifier 230, are input to the in-plane rotated face classifiers 30-7 through 30-12, to perform discrimination of the faces therein. Candidate images CP, which have been judged to represent faces by the −90°-0° out-of-plane rotated candidate classifier 240, are input to the out-of-plane rotated face classifiers 40-1 through 40-4, to perform discrimination of the faces therein. Candidate images CP, which have been judged to represent faces by the +30°-90° out-of-plane rotated candidate classifier 250, are input to the out-of-plane rotated face classifiers 40-5 through 40-7, to perform discrimination of the faces therein. In this manner, the number of candidate images CP to be discriminated by the target detecting means 20 is reduced, thereby accelerating the discrimination operations. At the same time, the false positive detection rate of the target discriminating apparatus 200 can be kept low.

Note that in the embodiment of FIG. 10, a case has been described in which the candidate classifier 212 comprises the two candidate detecting means 113 and 114. Alternatively, a single candidate classifier 12 may be provided, as in the case of the embodiment of FIG. 1. As a further alternative, a plurality of the candidate narrowing means 210 may be provided. In this case, the plurality of candidate narrowing means 210 may be provided in a cascade structure, and the angular ranges capable of being discriminated are narrower from the upstream side to the downstream side of the cascade.

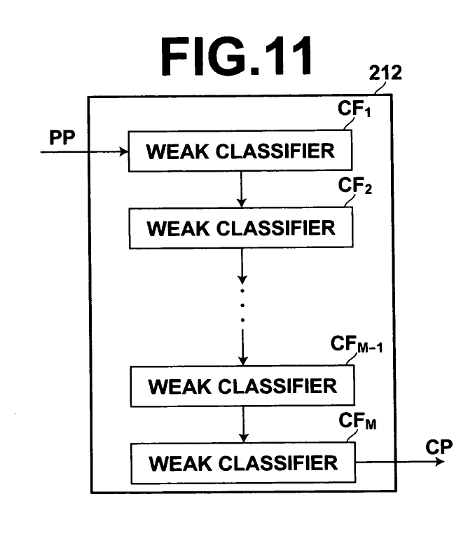

FIG. 11 is a block diagram that illustrates the configuration of a candidate classifier 212 of a target discriminating apparatus according to a third embodiment of the present invention. Note that the constituent parts of the candidate classifier 212 which are the same as those illustrated in FIG. 1 will be denoted by the same reference numerals, and detailed descriptions thereof will be omitted.

The candidate classifier 212 of FIG. 11 differs in structure from the candidate classifier 12 of FIG. 3. Note that the candidate classifier 212 is illustrated in FIG. 11, but the structure thereof may also be applied to the in-plane rotated face classifier 30, the out-of-plane rotated face classifier 40, and the candidate narrowing means 210 as well.

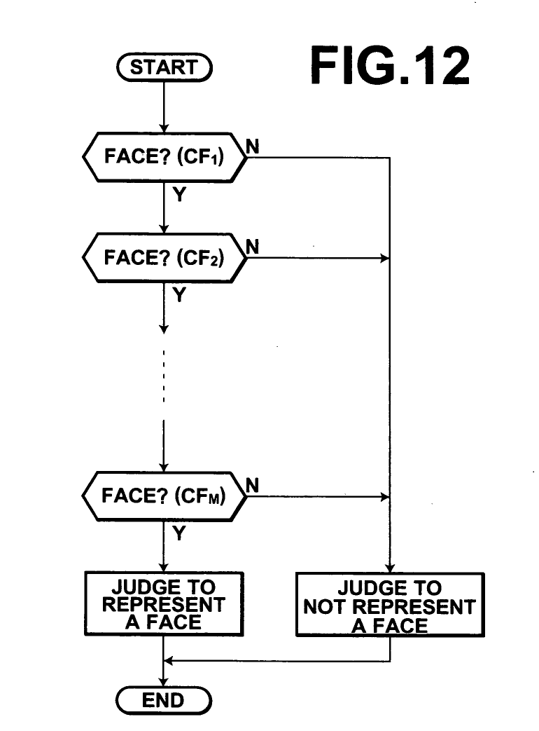

The weak classifiers CF₁ through CF_{M} of the candidate classifier 212 are arranged in a cascade structure. That is, according to the candidate classifier of FIG. 3, a score is output as the sum of the discrimination scores βₘ·fₘ(x) of each of the weak classifiers CF₁ through CF_{M} are output according to Formula (1). In contrast, the candidate classifier 212 only outputs partial images PP that all of the weak classifiers CF₁ through CF_{M} have discriminated to be faces as candidate images CP, as illustrated in the flow chart of FIG. 12.

Specifically, whether the discrimination score βₘ·fₘ(x) of each weak classifier CFₘ is greater than or equal to a threshold value Sref is judged. A partial image PP is judged to represent a face when the discrimination score βₘ·fₘ(x) is equal to or greater than the threshold value Sref (βₘ·fₘ(x)≧Sref). Discrimination is performed by a downstream weak classifier CFₘ₊₁ only on partial images in which faces have been discriminated by the weak classifier CFₘ. Partial images PP in which faces have not been discriminated by the weak classifier CFₘ are not subjected to discrimination operations by the downstream weak classifier CFₘ₊₁.

The number of partial images PP to be discriminated by the downstream weak classifiers can be reduced by this structure, and accordingly, the discrimination operations can be accelerated. Further, learning may be performed by the candidate classifier 212, having the weak classifiers CF₁ through CF_{M} in the cascade structure, employing the in-plane rotated sample images FSP and the out-of-plane rotated sample images SSP in addition to the reference sample images SP. In this case, the number of partial images PP to undergo the discrimination operations by the target detecting means 20 is reduced, thereby accelerating the discrimination operations. At the same time, the false positive detection rate of the target detecting means 20 can be kept low.

The details of the learning process of the candidate classifier 212 are disclosed in U.S. Patent Application Publication No. 20020102024. Specifically, sample images are input to each of the weak classifiers CF₁ through CF_{M}, and confidence values β₁ through β_{M} are calculated for each of the weak classifiers. Then, a weak classifier CFₘᵢₙ having the lowest confidence value βₘᵢₙ is selected. The weights of sample images LP which are correctly discriminated by the weak classifier CFₘᵢₙ are decreased, and the weights of sample images LP which are erroneously discriminated by the weak classifier CFₘᵢₙ are increased. Learning of the candidate classifier 212 is performed by repeatedly updating the weights of the sample images LP in this manner for a predetermined number of times.

Note that in FIG. 11, each of the discrimination scores βₘ·fₘ(x) are individually compared against the threshold value Sref to judge whether a partial image PP represents a face. Alternatively, discrimination may be performed by comparing the sum Σᵣ₌₁^{m}βₘ·fₘ(x) of the discrimination scores of upstream weak classifiers CF₁ through CFₘ₋₁ against a predetermined threshold value S1ref, as represented by Formula (6).
Σr=1^{m}βᵣ·fᵣ(x)≧S1ref (6)

The discrimination accuracy can be improved by this method, because judgment can be performed while taking the discrimination scores of upstream weak classifiers into consideration. The target detecting means 20 may perform learning employing the in-plane rotated sample images FSP and the out-of-plane rotated sample images SSP in addition to the reference sample images SP. In this case, the discrimination operations can be accelerated, while maintaining detection accuracy. Note that when the candidate classifier 212 that performs judgment according to Formula (6) performs learning, after learning of a weak classifier CFₘ is complete, the output thereof is designated as the first weak classifier with respect to a next weak classifier CFₘ₊₁, and learning of the next weak classifier CFₘ₊₁ is initiated (for details, refer to S. Lao et al., “Fast Omni-Directional Face Detection”, MIRU2004, pp. II271-II276, July 2004). The in-plane rotated sample images FSP and the out-of-plane rotated sample images SSP are also employed in the learning process for these weak classifiers, in addition to the reference sample images SP.

The present invention is not limited to the embodiments described above. For example, in the embodiments described above, the discrimination targets are faces. However, the discrimination target may be any object that may be included within images, such as eyes, clothes, or cars.

In addition, the sizes of the reference sample images SP, the in-plane rotated sample images FSP and the out-of-plane rotated sample images SSP illustrated in FIG. 7 may be varies in 0.1× increments within a range of 0.7× to 1.2×, and the sample images of various sizes may be employed in the learning process.

A case has been described in which the candidate classifier 12 illustrated in FIG. 3 performs learning employing the in-plane rotated sample images FSP and the out-of-plane rotated sample images SSP. Alternatively, learning may be performed employing only the in-plane rotated sample images. In this case, the out-of-plane rotated face classifier 40 of the target detecting means 20 becomes unnecessary.

Further, the candidate classifier 12 may perform learning employing out-of-plane in-plane rotated sample images, in which the out-of-plane rotated sample images SSP are rotated within the plane of the images, in addition to the in-plane rotated sample images FSP and the out-of-plane rotated sample images SSP.

Cases have been described in which the candidate classifiers 112 and 212 illustrated in FIGS. 9 and 10 comprise the in-plane rotated candidate detecting means 113 and the out-of-plane rotated candidate detecting means 114. The candidate classifiers 112 and 212 may further comprise out-of-plane in-plane rotated candidate detecting means, which has performed learning employing out-of-plane in-plane rotated sample images, in which the out-of-plane rotated sample images SSP are rotated within the plane of the images. Alternatively, the out-of-plane rotated candidate detecting means 114 may perform learning employing the out-of-plane rotated images and the out-of-plane in-plane rotated images.

What is claimed is:

1. A learning method for a classifier that employs a plurality of discrimination results obtained by a plurality of weak classifiers to perform final discrimination regarding whether an image represents a discrimination target, comprising the steps of:
learning reference sample images of the discrimination target, in which the discrimination targets are facing a predetermined direction; and
learning in-plane rotated sample images of the discrimination target, in which the discrimination targets are rotated within the plane of the reference sample images.

2. A learning method for a classifier as defined in claim 1, further comprising the step of:
learning out-of-plane rotated sample images of the discrimination target, in which the direction that the discrimination targets are facing in the reference sample images is rotated.

3. A target discriminating apparatus, comprising:
partial image generating means, for scanning a subwindow of a set number of pixels over an entire image to generate partial images;
candidate detecting means, for judging whether the partial images generated by the partial image generating means represents a discrimination target, and detecting partial images which possibly represent the discrimination target as candidate images; and
discrimination target judging means, for judging whether the candidate images detected by the candidate detecting means represent the discrimination target;
the candidate detecting means being equipped with a candidate classifier that employs a plurality of discrimination results obtained by a plurality of weak classifiers to perform final discrimination regarding whether the partial images represent the discrimination target; and
the candidate classifier learning reference sample images of the discrimination target, in which the discrimination targets are facing a predetermined direction, and in-plane rotated sample images of the discrimination target, in which the discrimination targets are rotated within the plane of the reference sample images.

4. A target discriminating apparatus as defined in claim 3, wherein the candidate classifier further learns:
out-of-plane rotated sample images of the discrimination target, in which the direction that the discrimination targets are facing in the reference sample images is rotated; and
out-of-plane in-plane rotated sample images of the discrimination target, in which the discrimination targets within the out-of-plane rotated sample images are rotated within the plane of the images.

5. A target discriminating apparatus as defined in claim 3, wherein:
the plurality of weak classifiers are arranged in a cascade structure; and
judgment is performed by downstream weak classifiers on partial images, which have been judged to represent the discrimination target by an upstream weak classifier.

6. A target discriminating apparatus as defined in claim 4, wherein:
the candidate classifier learns a plurality of in-plane rotated sample images having different angles of rotation, and a plurality of out-of-plane rotated sample images having different angles of rotation.

7. A target discriminating apparatus as defined in claim 4, wherein the candidate detecting means comprises a candidate narrowing means, for narrowing a great number of candidate images judged by the candidate classifier to a smaller number of candidate images, the candidate narrowing means comprising:
an in-plane rotated classifier, having a plurality of weak classifiers which have learned the reference sample images and the in-plane rotated sample images; and
an out-of-plane rotated classifier, having a plurality of weak classifiers which have learned the reference sample images and the out-of-plane rotated sample images.

8. A target discriminating apparatus as defined in claim 7, wherein:
the candidate detecting means comprises a plurality of the candidate narrowing means having cascade structures;
each candidate narrowing means is equipped with the in-plane rotated classifier and the out-of-plane rotated classifier; and
the angular ranges of the discrimination targets within the partial images capable of being discriminated by the in-plane rotated classifiers and the out-of-plane rotated classifiers are narrower from the upstream side to the downstream side of the cascade.

9. A program that causes a computer to function as:
partial image generating means, for scanning a subwindow of a set number of pixels over an entire image to generate partial images;
candidate detecting means, for judging whether the partial images generated by the partial image generating means represents a discrimination target, and detecting partial images which possibly represent the discrimination target as candidate images; and
discrimination target judging means, for judging whether the candidate images detected by the candidate detecting means represent the discrimination target;
the candidate detecting means being equipped with a candidate classifier that employs a plurality of discrimination results obtained by a plurality of weak classifiers to perform final discrimination regarding whether the partial images represent the discrimination target; and
the candidate classifier learning reference sample images of the discrimination target, in which the discrimination targets are facing a predetermined direction, and in-plane rotated sample images of the discrimination target, in which the discrimination targets are rotated within the plane of the reference sample images.

10. A computer readable medium having recorded therein a program that causes a computer to function as:
partial image generating means, for scanning a subwindow of a set number of pixels over an entire image to generate partial images;
candidate detecting means, for judging whether the partial images generated by the partial image generating means represents a discrimination target, and detecting partial images which possibly represent the discrimination target as candidate images; and
discrimination target judging means, for judging whether the candidate images detected by the candidate detecting means represent the discrimination target;
the candidate detecting means being equipped with a candidate classifier that employs a plurality of discrimination results obtained by a plurality of weak classifiers to perform final discrimination regarding whether the partial images represent the discrimination target; and
the candidate classifier learning reference sample images of the discrimination target, in which the discrimination targets are facing a predetermined direction, and in-plane rotated sample images of the discrimination target, in which the discrimination targets are rotated within the plane of the reference sample images.
